(19) United States
(12) Patent Application Publication
(10) Pub. No.: US 2026/0120689 A1
(43) Pub. Date: Apr. 30, 2026

(54) ASSESSING CONVERSATIONAL CONCORDANCE USING LARGE LANGUAGE MODELS

(71) Applicant: International Business Machines Corporation, Armonk, NY (US)

(72) Inventors: Jonathan Lenchner, Greenwich, CT (US); Dinesh C. Verma, New Castle, NY (US); Shiqiang Wang, Mount Kisco, NY (US)

(21) Appl. No.: 18/926,471

(22) Filed: Oct. 25, 2024

(51) Int. Cl. G10L 15/22; G10L 15/16; G10L 17/00; G10L 25/78

(52) U.S. Cl. CPC G10L 15/22; G10L 15/16; G10L 17/00; G10L 25/78; G10L 2015/225

(57) ABSTRACT

Examples described herein provide systems and methods for assessing conversational concordance using large language models. Aspects include a user interface for inputting goals and parameters, a large language model module for analyzing conversations, and agents for monitoring and parsing data. Aspects also include evaluating the predictability of utterances, calculating concordance scores, and providing feedback. A technical depth assessment module adjusts feedback based on the conversation's complexity.

### BACKGROUND

The disclosure relates generally to communication technologies and more specifically to assessing conversational concordance using large language models.

Effective communication often encounters challenges when one party misjudges the technical familiarity of the other party. This misalignment can occur in various forms of communication, including spoken conversations, emails, and other digital mediums. One common issue is when one person speaks in a manner that is not easily understood by another, leading to misunderstandings and ineffective communication.

Conversational concordance is a measure of the alignment and mutual understanding between parties in a conversation. It encompasses various aspects such as word choice, tone, pace, and overall communication style. High conversational concordance indicates that both parties are on the same page, making the conversation more productive and engaging. Conversely, low conversational concordance suggests a disconnect, where one party may be speaking “over the head” of the other, resulting in confusion and miscommunication.

### SUMMARY

According to one aspect of the present invention, a computer-implemented method for identifying that a user in a multi-party conversation is speaking in a way that is likely to be misunderstood by one or more of the parties to the multi-party conversation is provided. The method includes receiving a user corpus associated with the user, wherein the user corpus comprises one or more of writings created by the user and user utterances spoken by the user, determining that a multi-party conversation has begun, and identifying one or more parties participating in the multi-party conversation. The method also includes translating one or more utterances from the multi-party conversation into text in real time, identifying a speaking party of the one or more parties in real time as each utterance is spoken, and generating a party corpus for each of the one or more parties. The method further includes for each of the one or more parties, computing, by a large language model (LLM), a conversational concordance between the user and each party based on the user corpus and a respective associated party corpus, wherein the concordance comprises a probability that a given utterance would have been the next utterance in the multi-party conversation between the user and the party and providing feedback to the user based on the concordance.

The above features and advantages, and other features and advantages, of the disclosure are readily apparent from the following detailed description when taken in connection with the accompanying drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of one or more embodiments described herein are apparent from the following detailed description taken in conjunction with the accompanying drawings in which:

FIG. 1 illustrates a block diagram of a computing environment, according to one or more embodiments;

FIG. 2 illustrates a block diagram of a conversational concordance monitoring system, according to one or more embodiments;

FIG. 3 illustrates a block diagram of the operation of system for assessing conversational concordance using large language models, according to one or more embodiments;

FIG. 4 illustrates a flow chart diagram of a method for assessing conversational concordance using large language models, according to one or more embodiments;

FIG. 5 illustrates concordance graphs according to one or more embodiments; and

FIG. 6 illustrates a flow chart diagram of a method for assessing conversational concordance during a presentation using large language models, according to one or more embodiments.

The detailed description explains embodiments of the disclosure, together with advantages and features, by way of example with reference to the drawings.

### DETAILED DESCRIPTION

Effective communication often encounters challenges when one party misjudges the technical familiarity of the other party. This misalignment can occur in various forms of communication, including spoken conversations, emails, and other digital mediums. One common issue is when one person speaks in a manner that is not easily understood by another, leading to misunderstandings and ineffective communication.

Existing solutions to address communication misalignment often rely on subjective feedback or post-conversation analysis, which may not provide real-time insights. These methods fail to dynamically assess the evolving nature of a conversation and do not offer immediate corrective measures. Additionally, current technologies do not adequately account for the technical depth of the conversation or the specific vocabulary used by the participants, resulting in limited effectiveness in improving conversational alignment.

The disclosed system addresses these issues by utilizing large language models to assess conversational concordance in real-time. The system involves agents that monitor the conversation, analyze the predictability of utterances, and provide feedback to the user. This feedback includes graphical depictions of the conversation's progress with respect to its conversational concordance, highlighting areas where one party may be speaking “over the head” of another. The system can be applied to various conversational contexts, including in-person discussions and digital communications, and can be extended to multi-party conversations and presentations.

Descriptions of various embodiments of the present disclosure are presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

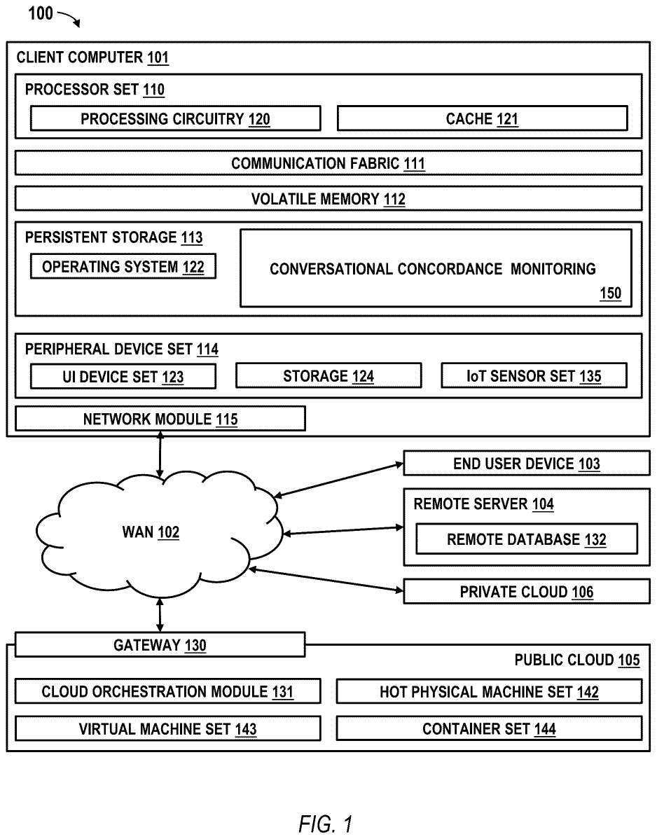

FIG. 1 illustrates a computing environment 100, according to an embodiment. Computing environment 100 contains an example of an environment for the execution of at least some of the computer code involved in performing the inventive methods, such as conversational concordance monitoring, as shown at block 150. In addition to a controller for controlling the operations of a metal cutting tool, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in persistent storage 113 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

According to one or more embodiments, the computing environment 100 can provide for remote data storage. For example, the computer 101 can be a cloud storage system or other suitable system for storing data that is accessible to a user remotely, such as by accessing the computer 101 using the end user device 103. That is, a user can send a user operation (also referred to as a “user request”) from the end user device 103 to the computer 101 via the WAN 102. Although the user operation may appear to be simple, such as uploading an object to a cloud storage system, the complications of operating a cloud computing system often have side effects and produce ancillary data, which may be consumed by both the operator of the system (e.g., the computer 101) and by users or other components of the cloud architecture (e.g., the computing environment 100). Ancillary data may be created by user operations that trigger the creation of the ancillary data. Ancillary data may be resource consumption information, notification data, and/or the like, including combinations and/or multiples thereof. Data for an independent event may be inferred from another event (e.g., event to update resource consumption information for an entity in a system also means that the total consumption information for the owner of the entity is also updated).

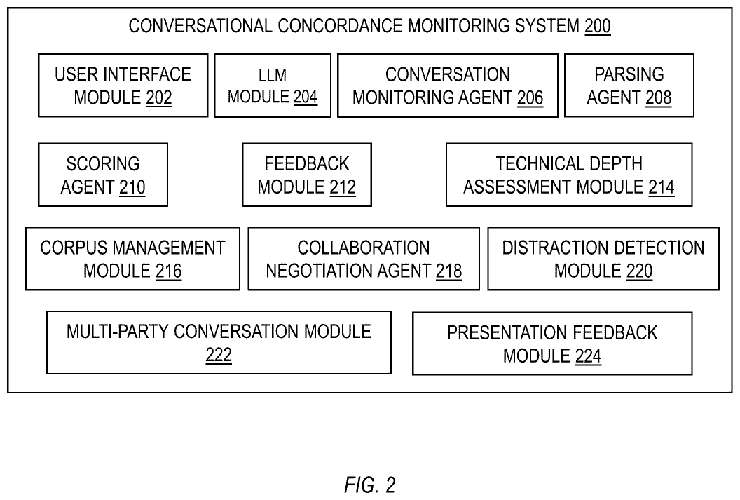

Referring now to FIG. 2, a block diagram of a conversational concordance monitoring system 200 is provided. The system 200 includes a user interface (UI) 202, which allows users to interact with the system. The UI 202 provides a platform for users to input goals and parameters for the conversation assessment process, such as the desired level of technicality and specific vocabulary. The UI 202 also displays feedback and graphical depictions of the conversation's progress.

The large language model (LLM) module 204 is responsible for analyzing the conversation and predicting the next utterances. The LLM module 204 uses advanced natural language processing techniques to assess the predictability of utterances and determine the level of conversational concordance between the parties in conjunction with the scoring agent 210. The LLM module 204 interacts with the corpus management module 216 to access relevant data for training and analysis, improving the accuracy of the concordance assessment over time.

The conversation monitoring agent 206 listens to the conversation in real-time, capturing audio or text data. The conversation monitoring agent 206 identifies the speakers and segments the conversation into individual utterances for further analysis by the LLM module 204. The conversation monitoring agent 206 works in conjunction with the parsing agent 208 to ensure accurate data capture and segmentation.

The parsing agent 208 converts the captured audio or text data into a structured format, including text, pauses, and intonation markings. The parsing agent 208 provides this structured data to the LLM module 204 for analysis. The parsing agent 208 ensures that the data is in a format suitable for the LLM module 204 to perform predictive analysis.

The scoring agent 210 evaluates the predictability of each utterance based on the LLM's analysis. The scoring agent 210 calculates a concordance score for each utterance, indicating how well the utterance aligns with the expected conversation flow. The scoring agent 210 uses the data provided by the parsing agent 208 and the analysis from the LLM module 204 to generate these scores.

The feedback renderer 212 generates visual or spoken feedback for the user based on the concordance scores. The feedback renderer 212 creates graphical depictions of the conversation's progress, highlighting areas where one party may be speaking “over the head” of another and providing suggestions for improving conversational alignment. The feedback renderer 212 interacts with the UI 202 to display this feedback to the user.

The technical depth assessment module 214 evaluates the technical content of the conversation. The technical depth assessment module 214 assigns a technical depth score to the conversation, which is used to adjust the expected rate of convergence and provide more accurate feedback. The technical depth assessment module 214 works with the LLM module 204 to incorporate the technical depth into the concordance analysis.

The corpus management module 216 manages the corpora of documents and previous conversations for each party. The corpus management module 216 ensures that the LLM module 204 has access to relevant data for training and analysis, improving the accuracy of the concordance assessment. The corpus management module 216 interacts with external data sources to update and maintain the corpora.

The collaboration negotiation agent 218 negotiates with the agents of other parties to determine if they are willing to collaborate in the conversation assessment process. The collaboration negotiation agent 218 ensures that all parties'data are used effectively to provide accurate feedback. The collaboration negotiation agent 218 works with the corpus management module 216 to access the necessary data from other parties.

The distraction detection module 220 monitors the conversation for signs of distraction, such as long pauses, off-topic remarks, or visual cues in case the meeting is face-to-face and being captured via one or more cameras. The distraction detection module 220 adjusts the concordance scores accordingly and provides feedback to help the parties stay focused on the conversation, and also, in case one party to the conversation appears especially distracted, to indicate this fact to the other parties, so that they may alter their communication or expectations accordingly. The distraction detection module 220 interacts with the conversation monitoring agent 206 to detect these signs of distraction.

The multi-party conversation module 222 extends the system's capabilities to handle conversations involving more than two parties. The multi-party conversation module 222 provides feedback on pairwise conversations between each pair of parties and can aggregate the feedback to show how well each party is communicating with the group. The multi-party conversation module 222 works with the scoring agent 210 and the feedback renderer 212 to generate and display this feedback.

The presentation feedback module 224 adapts the system for use in presentations or formal talks. The presentation feedback module 224 provides feedback to the speaker on how well they are reaching the audience, identifying terminological gaps and suggesting references to help the audience understand the content. The presentation feedback module 224 interacts with the technical depth assessment module 214 and the feedback renderer 212 to provide this feedback. By integrating these components, the system 200 can effectively assess conversational concordance using large language models, providing real-time feedback to improve communication and assist in mutual understanding between parties.

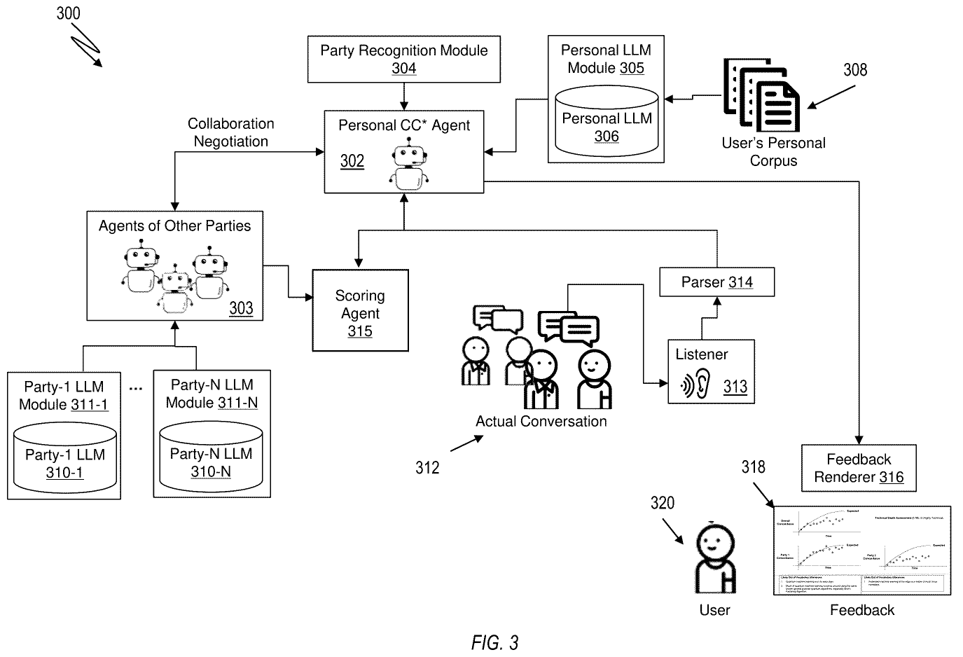

Referring now to FIG. 3, a block diagram illustrating the operation of a system 300 for assessing conversational concordance using large language models according to one or more embodiments is shown. The system 300 includes a personal conversational concordance agent 302, a party recognition module 304, a personal large language model module 305, a personal large language model 306, a user's personal corpus 308, a party-1 large language model 310-1, and if there are N parties to the conversation, a party-i large language model 310-i for each i such that 2≤i≤N, agents of other parties 303, an actual conversation 312, a listener 313, a parser 314, a scoring agent 315, a feedback renderer 316, a user 318, and feedback 320.

In exemplary embodiments, the personal conversational concordance agent 302 interacts with the party recognition module 304 to identify parties in the conversation. For example, it can use facial recognition software to identify participants in an in-person meeting or utilize login credentials in a digital communication platform to recognize participants. The personal conversational concordance agent 302 also collaborates with the agents of other parties 303 to negotiate data sharing and access. For instance, it can request access to shared documents or previous conversation logs to enhance the accuracy of the concordance assessment. In exemplary embodiments, the party recognition module 304 identifies the parties involved in the conversation and provides this information to the personal conversational concordance agent 302. It can use voice recognition technology to distinguish between different speakers based on their unique vocal patterns. Additionally, it can employ user authentication and login information in digital platforms to accurately track participants.

In exemplary embodiments, the personal large language model module 305 (which includes a personal large language model 306) processes the data from the user's personal corpus 308 to be able to predict next utterances that are consistent with the user's communication style and vocabulary. It utilizes the frequency and context of specific terms used by the user to build a comprehensive language model. The personal large language model module 305 ingests the conversation thus far and predicts what it believes to be the next utterance. For example, it can generate a list of most likely responses based on the user's past communication patterns and on real-time conversation flow. In exemplary embodiments, the user's personal corpus 308 stores the user's writings and spoken utterances. It can include emails, reports, and recorded conversations. The user's personal corpus 308 provides the necessary data for the personal large language model 306 to analyze the user's communication patterns. For instance, it can identify commonly used phrases or technical jargon specific to the user's field.

In exemplary embodiments, the party-1 large language model module 311-1 and party-N large language model module 311-N include the language model modules 310-1 and 310-2 for other parties in the conversation. These modules 311-1 and 311-N analyze the communication styles and vocabularies of the respective parties, providing data to the personal conversational concordance agent 302 for concordance assessment. For example, they can process previous interactions with the user to predict next utterances that are consistent with the other parties'preferred communication styles or analyze their written documents to identify key terms and phrases. In exemplary embodiments, the agents of other parties 303 collaborate with the personal conversational concordance agent 302 to share data and improve the accuracy of the concordance assessment. They can provide access to their own language models or share relevant documents and conversation logs. This collaboration ensures that the system has access to relevant data from all parties involved in the conversation.

In exemplary embodiments, the actual conversation 312 represents the real-time interaction between the user 318 and other parties. The listener 313 captures the audio or text data from the conversation, which is then processed by the parser 314. For example, the listener 313 can record the conversation using a microphone or capture text data from a chat application. In exemplary embodiments, the listener 313 captures the audio or text data from the actual conversation 312. The listener 313 ensures that the system accurately records the conversation for further analysis. For instance, the listener 313 can use high-fidelity microphones to capture clear audio or employ screen recording software to capture text-based interactions. In exemplary embodiments, the parser 314 converts the captured audio or text data into a structured format, including text, pauses, and intonation markings. can use speech-to-text technology to transcribe spoken words into text or employ natural language processing algorithms to identify pauses and intonation changes. The parser 314 provides this structured data to the personal large language model 306 for analysis.

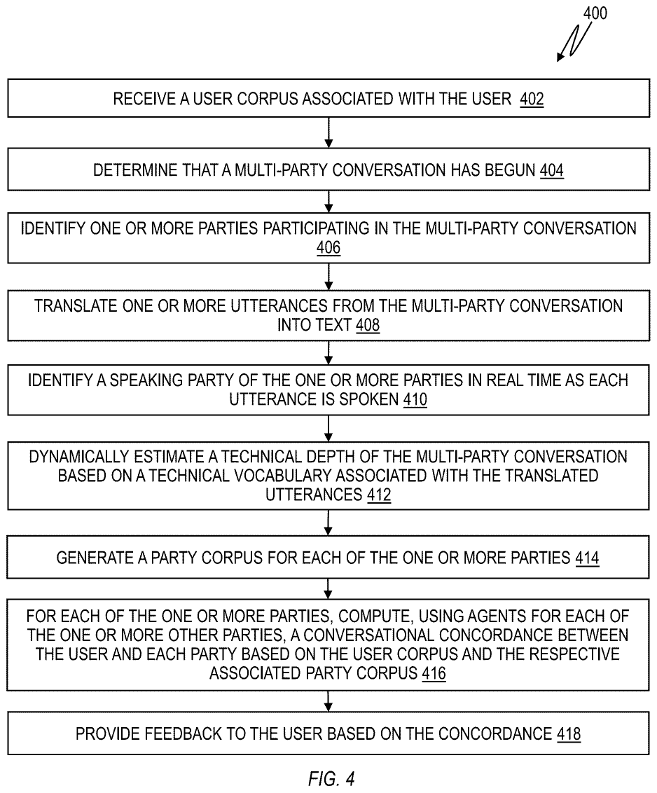

In exemplary embodiments, the scoring agent 315 evaluates the predictability of each utterance based on the analysis from the personal large language model module 305. It calculates a concordance score for each utterance, indicating how well the utterance aligns with the expected conversation flow. For example, it can compare the predicted next utterance with the actual spoken words or analyze the consistency of the conversation's technical depth (see discussion of how this process can be done in the discussion of block 412 in the flowchart shown in FIG. 4). In exemplary embodiments, the feedback renderer 316 generates visual or spoken feedback 320 for the user 318 based on the concordance scores. It creates graphical depictions of the conversation's progress, highlighting areas where one party may be speaking “over the head” of another and providing suggestions for improving conversational alignment. For instance, it can display a real-time graph showing the alignment between participants or provide spoken feedback through a voice assistant. In exemplary embodiments, the user 318 receives the feedback 320 generated by the feedback renderer 316. The feedback 320 helps the user 318 adjust their communication style in real-time to enhance mutual understanding and conversational concordance. For example, the user 318 can receive a notification to clarify their language if they are using many words that are out of vocabulary for one or more of the other participants, or a suggestion to clarify a specific term.

Referring now to FIG. 4, a flow chart diagram of a method 400 for assessing conversational concordance using large language models according to one or more embodiments is shown. In exemplary embodiments, the method 400 may be performed by the system 200 shown in FIG. 2. The method 400 begins at block 402 by receiving a user corpus associated with the user. The user corpus may include writings created by the user and/or user utterances spoken by the user. In exemplary embodiments, the corpus management module 216 is configured to receive a user corpus associated with the user, which ensures that the system has access to relevant data for analyzing the user's communication style and vocabulary. Next, as shown at block 404, the method 400 includes determining that a multi-party conversation has begun. In exemplary embodiments, the conversation monitoring agent 206 is configured to determine that a multi-party conversation has begun, as the conversation monitoring agent 206 continuously monitors for the start of a conversation, ensuring that the analysis begins promptly when the conversation starts.

As shown at block 406, the method 400 includes identifying one or more parties participating in the multi-party conversation. In exemplary embodiments, the conversation monitoring agent 206 is configured to identify the parties participating in the multi-party conversation. In one embodiment, the conversation monitoring agent 206 can utilize voice recognition technology to identify the participants in the conversation. Each participant's voice is unique, and the system can be trained to recognize these unique vocal patterns. When a participant speaks, the conversation monitoring agent 206 captures the audio and analyzes the voice characteristics, such as pitch, tone, and speech patterns. By comparing these characteristics to a database of known participants, the system can accurately identify who is speaking. For example, in a business meeting, the system can recognize the voices of different team members and attribute their utterances accordingly. In digital communication platforms, such as video conferencing or chat applications, the conversation monitoring agent 206 can identify participants based visual features, in the case of video conferencing, or on user authentication and login information, especially in the case of chat applications. When users join a conversation, they typically log in with unique credentials, such as usernames or email addresses. The system can use this information to track and identify each participant. For instance, during a video conference, the system can associate each participant's video feed and audio input with their login credentials, ensuring accurate identification throughout the conversation. This method is particularly useful in virtual meetings where participants may not be physically present (and their video cameras may be turned off).

Next, as shown at block 408, the method 400 includes translating one or more utterances from the multi-party conversation into text in real time. In exemplary embodiments, the parsing agent 208 is configured to convert spoken words into text, including pauses and intonation markings, enabling the LLM module 204 to analyze the conversation accurately. Intonation markings are annotations used in text to represent the variations in pitch, tone, and stress that occur in spoken language. These markings help capture the nuances of speech, such as rising or falling pitch at the end of a sentence, emphasis on certain words, and changes in tone that convey emotions or questions. In the context of natural language processing, intonation markings are used to provide a more accurate representation of spoken language, enabling better analysis of the conversation's dynamics.

As shown at block 410, the method 400 includes identifying a speaking party of the one or more parties in real time as each utterance is spoken. In exemplary embodiments, the conversation monitoring agent 206 is configured to determine who is speaking at any given moment during the conversation, ensuring accurate attribution of utterances. Next, as shown at block 412, the method 400 includes dynamically estimating a technical depth of the multi-party conversation based on a technical vocabulary associated with the translated utterances. In exemplary embodiment, the technical depth assessment module 214 is configured to evaluate the complexity and technicality of the conversation. In one embodiment, the technical depth assessment module 214 can analyze the vocabulary used in the conversation to determine its complexity and technicality. By comparing the words and phrases used in the conversation to a predefined technical vocabulary database, the technical depth assessment module 214 can assess the level of technical jargon and specialized terms being used. For example, in a conversation about quantum computing, the presence of terms like “qubits,” “superposition,” and “entanglement” might indicate a modest level of technical depth. The technical depth assessment module 214 can then adjust the expected rate of convergence based on the complexity of the vocabulary, providing more accurate feedback to the participants. In another embodiment, the technical depth assessment module 214 can perform syntactic and semantic analysis of the conversation to evaluate its technical depth. For example, the words used that are out of vocabulary for one or more of the participants can be gathered and a search can be done for technical papers that include the given words (e.g. using Google Scholar). If the collection of documents returned have relatively few authors, the subject matter can be deemed highly specialized, and otherwise, not so highly specialized (as a function of degree).

As shown at block 414, the method 400 includes generating a party corpus for each of the one or more parties. In exemplary embodiments, the corpus management module 216 is configured to generate a party corpus for each of the one or more parties. In exemplary embodiments, the party corpus for each of the one or more parties is generated by compiling a collection of writings and/or utterances associated with each party, ensuring that the LLM module 204 has access to comprehensive data for accurate assessment.

Next, as shown at block 416, the method 400 includes computing, using agents for the other parties to the conversation, a conversational concordance between the user and each party based on the user corpus and the respective associated party corpus. In exemplary embodiments, a conversational concordance is separately computed for each of the one or more parties by the LLM module 204. The LLM module 204 utilizes its built-in natural language processing techniques to assess the predictability of utterances and determine the level of alignment between the user and each party. The process involves analyzing the context, predicting the next utterance, and calculating concordance scores. The LLM module 204 begins by analyzing the context of the conversation, examining the sequence of previous utterances, the topics being discussed, and the overall flow of the conversation. The context provides the necessary background information for the LLM to make accurate predictions about future utterances. The module uses the user corpus and the party corpus, which include writings and previous conversations, to understand the communication style and vocabulary of each participant. The LLM module 204 then tokenizes the text data, breaking down the conversation into smaller units such as words or subwords. These tokens are encoded into numerical representations that the LLM can process, capturing the semantic and syntactic information of the tokens. Using the encoded context, the LLM module 204 predicts the next utterance in the conversation, generating a probability distribution over possible next tokens. The model uses its trained parameters, optimized on large datasets, to make these predictions. The LLM can generate multiple potential next utterances, each with an associated probability. The LLM module 204 calculates concordance scores to assess the predictability of each utterance, comparing the predicted probability distribution with the actual tokens that follow in the conversation. Higher concordance scores indicate that the actual utterance closely matches the predicted utterance, suggesting a higher level of alignment between the user and the party. The LLM module 204 evaluates the overall alignment by aggregating the concordance scores over the course of the conversation, considering factors such as the consistency of high concordance scores, the presence of out-of-vocabulary words, and the technical depth of the conversation.

Next, based on the concordance scores and alignment evaluation, the method 400 includes providing feedback to the user. In exemplary embodiments, the feedback is provided by the feedback renderer 212, which generates visual or spoken feedback for the user, highlighting areas where one party may be speaking “over the head” of another and providing suggestions for improving conversational alignment. The feedback may include a graph tracking the concordance against what is expected for the multi-party conversation based on the technical depth, one graph associated with each user/party pair, and one graph averaged over the user and all parties. The feedback helps the user adjust their communication style in real-time to enhance mutual understanding and conversational concordance. By leveraging its built-in NLP capabilities, the LLM module 204 can accurately assess the predictability of utterances and determine the level of alignment between the user and each party, ensuring more effective conversations and reducing misunderstandings.

In one embodiment, the feedback provided by the system includes a graph tracking the concordance against what is expected for the multi-party conversation based on the technical depth. This graph visually represents how well the conversation aligns with the predicted flow, considering the complexity and technicality of the discussion.

By comparing the actual concordance with the expected concordance, users can identify areas where the conversation may be diverging from the anticipated path and make adjustments to improve mutual understanding.

In another embodiment, the feedback comprises one graph associated with each unique user/party pair. This approach allows users to see individual concordance scores for each participant in the conversation. By providing separate graphs for each user/party pair, the system helps users understand how well they are communicating with each specific participant. This detailed feedback enables users to tailor their communication style to better align with each party's understanding and expectations.

In a further embodiment, the feedback includes one graph averaged over the user and all parties. This aggregated graph provides an overall view of the conversation's concordance, showing the general alignment between the user and all participants. By presenting an averaged concordance score, the system offers a high-level perspective on the effectiveness of the communication, helping users identify broader trends and areas for improvement.

In another embodiment, the party corpus comprises all utterances spoken by the associated party within the multi-party conversation. This comprehensive data set includes every spoken contribution from each participant during the conversation. By analyzing all utterances, the system can accurately assess the conversational dynamics and provide precise feedback on the alignment between the user and each party.

In an additional embodiment, the party corpus includes utterances spoken by the associated party within one or more previous conversations. By incorporating historical data, the system can better understand each participant's communication style and vocabulary. This historical context allows the system to make more accurate predictions and provide more relevant feedback, enhancing the overall effectiveness of the conversation assessment.

In a further embodiment, the party corpus comprises one or more writings created by the associated party. These writings can include emails, reports, articles, or any other written documents authored by the participant. By analyzing these writings, the system gains insights into the participant's preferred language and terminology, improving the accuracy of the concordance assessment and feedback.

In another embodiment, the party corpus includes a recent conversation between the user and the associated party with a vocabulary exceeding a threshold similarity to the technical vocabulary. By focusing on recent interactions that share a high degree of vocabulary similarity, the system can provide more relevant and timely feedback. This approach ensures that the concordance assessment reflects the most current communication patterns and technical language used by the participants.

In addition to analyzing the predictability of utterances and the alignment of vocabulary, several other factors can be used to measure concordance in a conversation. These factors provide a more comprehensive understanding of how well the participants are communicating and can help identify areas for improvement. Some of these factors include speaking time allocation, which refers to the distribution of speaking time among the participants in a conversation. By measuring how much time each participant spends speaking, the system can assess whether the conversation is balanced or dominated by one party. A balanced speaking time allocation indicates that all participants are actively engaged and contributing to the discussion, which is a sign of high concordance. Conversely, if one participant dominates the conversation, it may suggest that the other parties are not fully understanding or engaging with the content, leading to lower concordance.

Speaking speed, or the rate at which participants speak, can also be an factor in measuring concordance. Variations in speaking speed can indicate differences in comfort levels, understanding, and engagement. For example, if one participant speaks significantly faster than the others, it may suggest that they are more familiar with the topic, while the others may struggle to keep up. In a conversation with good concordance, the speaking speeds of the participants tend to converge over the course of the conversation. In contrast, a lack of convergence of the speaking speeds is a marker of non-concordance. By analyzing speaking speed, the system can provide feedback on whether participants should adjust their pace to improve mutual understanding and alignment.

The emotional tone and sentiment of the conversation can also impact concordance. Positive emotions and sentiments, such as enthusiasm and agreement, can enhance alignment and mutual understanding. Negative emotions, such as frustration or disagreement, can create barriers to effective communication. By analyzing the emotional tone and sentiment of the conversation, the system can provide feedback on how participants can adjust their communication style to foster a more positive and aligned interaction.

Non-verbal cues, such as body language, facial expressions, and gestures, play a significant role in communication. While these cues are more challenging to analyze in digital conversations, they can provide valuable insights in face-to-face interactions. For example, nodding, eye contact, and open body language can indicate agreement and engagement, while crossed arms or lack of eye contact may suggest discomfort or disagreement. By incorporating non-verbal cues into the concordance assessment, the system can provide a more holistic view of the conversation dynamics.

By considering these additional factors, the system can provide a more comprehensive assessment of conversational concordance. This multi-faceted approach ensures that participants receive detailed and actionable feedback to improve their communication and achieve higher levels of mutual understanding and alignment.

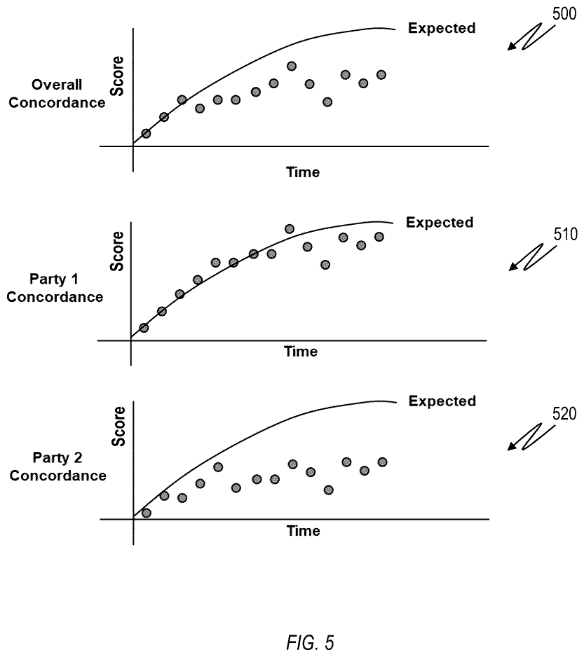

Referring now to FIG. 5, concordance graphs according to one or more embodiments are shown. FIG. 5 includes an overall concordance graph 500, a party 1 concordance graph 520, and a party 2 concordance graph 520. These graphs 500, 510, and 520 illustrate the concordance scores over time, comparing the actual scores to the expected scores. The overall concordance graph 500 represents the aggregated concordance score for both parties to the conversation during the course of the conversation. The overall concordance graph 500 plots the concordance score on the y-axis against time on the x-axis, showing how the overall alignment between the parties evolves throughout the conversation. The expected concordance curve is also depicted, providing a benchmark for comparison. The party 1 concordance graph 510 shows the concordance score specifically between the user (party 2) and party 1. The party 2 concordance graph 520 illustrates the concordance score between the user (party 1) and party 2. These graphs 510 and 520 plot the concordance score on the y-axis against time on the x-axis, demonstrating the alignment between the user and first and second parties, respectively, during the conversation. The expected concordance curve is shown to provide a reference for the expected alignment. In exemplary embodiments, the concordance graphs 500, 510, and 520 provide visual feedback on the conversational concordance, helping users understand how well they are communicating with each party and the overall group. The comparison with the expected concordance curves allows users to identify areas for improvement and adjust their communication style accordingly.

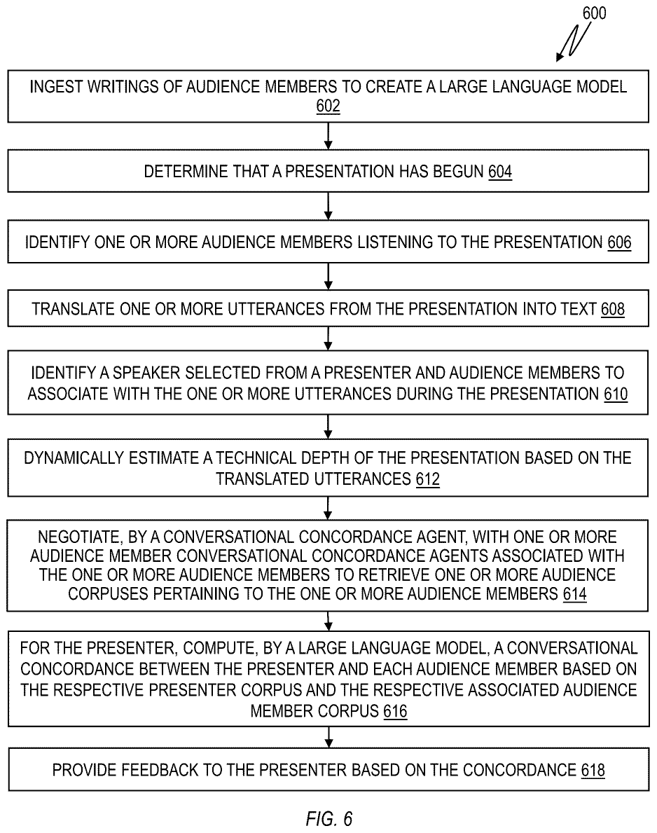

Referring now to FIG. 6, a flow chart diagram of a method 600 for assessing conversational concordance during a presentation using large language models according to one or more embodiments is shown. In exemplary embodiments, the method 600 may be performed by the system 200 shown in FIG. 2.

The method 600 begins at block 602 by ingesting the writings of the participants in the call/audience to create a large language model to assess how well the language of the presentation meshes with the words understandable by participants in the call/audience. This can be done by contacting the agents for these participants or by looking up their writings, if available on the web. The method 600 also includes determining that a presentation has begun, as shown at block 604. The conversation monitoring agent 206 is configured to determine that a presentation has begun, continuously monitoring for the start of the presentation to ensure that the analysis begins promptly. This determination can be made through various means, such as detecting the start of a scheduled event or recognizing specific cues in the presenter's speech or actions.

As shown at block 606, the method 600 involves identifying one or more audience members listening to the presentation. The conversation monitoring agent 206 identifies the audience members, utilizing voice recognition technology or user authentication and login information in digital communication platforms. This identification ensures that the system can accurately attribute utterances and provide relevant feedback to the presenter based on the audience's responses. Next, as shown at block 608m the method 600 includes translating one or more utterances from the presentation into text. The parsing agent 208 is configured to convert spoken words into text, including pauses and intonation markings, enabling the LLM module 204 to analyze the presentation accurately. Intonation markings help capture the nuances of speech, such as rising or falling pitch, emphasis on certain words, and changes in tone that convey emotions or questions.

The method 600 also includes involves identifying a speaker selected from the presenter and audience members to associate with the one or more utterances during the presentation, as shown at block 610. The conversation monitoring agent 206 determines who is speaking at any given moment, ensuring accurate attribution of utterances. This identification can be achieved through voice recognition technology or user authentication and login information in digital communication platforms. Next, as shown at block 612, the method 600 includes dynamically estimating a technical depth of the presentation based on the translated utterances. The technical depth assessment module 214 evaluates the complexity and technicality of the presentation. By analyzing the vocabulary used in the presentation and performing syntactic and semantic analysis, the module assesses the level of technical jargon and specialized terms being used, adjusting the expected rate of convergence accordingly.

The method 600 further includes negotiating a conversational concordance agent with one or more audience members to provide one or more suggestions pertaining to the audience members, as shown at block 614. The collaboration negotiation agent 218 negotiates with the agents of the audience members to determine if they are willing to collaborate in the presentation assessment process. This negotiation ensures that all parties'data is used effectively to provide accurate feedback. Next, as shown at block 616, the method 600 includes computing, by a large language model, a conversational concordance between the presenter and the respective audience member based on the respective presenter corpus and the respective audience member corpus. The LLM module 204 assesses the predictability of utterances and determines the level of alignment between the presenter and each audience member. The concordance includes a probability that a given utterance would have been the next utterance in the presentation between the presenter and the audience member.

The method 600 also includes providing feedback to the presenter based on the concordance, as shown at block 618. The feedback renderer 212 generates visual or spoken feedback for the presenter, highlighting areas where the presenter may be speaking “over the head” of the audience members and providing suggestions for improving alignment. The feedback may include a graph tracking the concordance against what is expected for the presentation based on the technical depth, helping the presenter adjust their communication style in real-time to enhance mutual understanding and engagement with the audience. In exemplary embodiments, the feedback indicates how well the presenter is reaching one or more audience members based on the concordance. In one embodiment, the feedback aggregates all the audience members and indicates that a subset of the audience members are confused based on the concordance.

During the method for assessing conversational concordance using large language models according to one or more embodiments shown in FIG. 4 and the method for assessing conversational concordance during a presentation using large language models shown in FIG. 6, feedback can be provided to the user (the presenter) in various ways to ensure timely and effective communication. In exemplary embodiments, the feedback provided to a presenter during a presentation is configured to only be visible to the presenter and is provided in a manner to not interfere with the presentation.

In exemplary embodiments, wearable devices, such as smartwatches and fitness trackers, can deliver real-time feedback through haptic feedback, like vibrations or gentle taps, and visual feedback on the device's screen, allowing users to quickly glance at the information without interrupting their activities. Email is another widely used method for providing feedback, especially for detailed and comprehensive reports for after-the-fact feedback. Users can receive feedback in the form of emails that include graphical depictions of the conversation's progress, concordance scores, and suggestions for improvement, allowing them to review the feedback at their convenience. SMS (Short Message Service) is effective for delivering brief and immediate feedback to users'mobile phones, providing quick updates and suggestions, ensuring prompt receipt of time-sensitive information. Mobile applications can provide feedback through push notifications and in-app messages, offering real-time alerts and detailed feedback within the app, along with interactive features like graphs and charts to help users visualize the feedback more effectively. For users working on desktop computers or laptops, feedback can be provided through desktop notifications, which appear as pop-up messages on the screen, alerting users to important updates and suggestions without requiring them to switch between applications. Voice assistants, such as Amazon Alexa, Google Assistant, and Apple Siri, can deliver feedback through spoken messages, allowing users to receive real-time verbal feedback and suggestions without having to read text, and providing interactive feedback by enabling users to ask questions and receive responses. Visual displays, such as monitors or digital signage, can show graphical depictions of the conversation's progress, concordance scores, and suggestions for improvement, making them particularly useful in collaborative environments where multiple users can view the feedback simultaneously. By utilizing these various methods, the system can ensure that users receive timely and effective feedback, helping them improve their communication and achieve higher levels of mutual understanding and alignment.

In one embodiment, during the method for assessing conversational concordance using large language models according to one or more embodiments shown in FIG. 4, the system provides real-time feedback to participants in a conversation, suggesting adjustments to their communication style to improve mutual understanding. During the conversation, the large language model (LLM) module 204 continuously analyzes the predictability of utterances and the level of alignment between the participants. The technical depth assessment module 214 evaluates the complexity and technicality of the conversation, identifying instances where one participant may be using terms that are too complex for the other party to understand. When the system detects that one participant is consistently using complex terms that may be difficult for the other party to comprehend, the feedback renderer 212 generates a suggestion for the participant to use less complex terms. This feedback can be delivered through various methods, such as a subtle vibration on a wearable device, a pop-up notification on a mobile application, or a desktop notification. The feedback message might say, “Consider using simpler terms to improve understanding,” or “Try explaining this concept in more basic language.”

For example, during a technical discussion about quantum computing, if one participant frequently uses terms like “superposition” and “entanglement,” which the other party may not be familiar with, the system can suggest using simpler explanations or analogies. The participant might be prompted to explain “superposition” as “a state where something can be in multiple configurations at once” and “entanglement” as “a connection between particles that affects their behavior, even when they are far apart.” By providing this real-time feedback, the system helps participants adjust their communication style to better match the technical familiarity of the other party. This approach enhances conversational concordance, helping to ensure that both parties are on the same page and reducing the likelihood of misunderstandings. The feedback mechanism is designed to be non-intrusive, allowing participants to make adjustments without disrupting the flow of the conversation.

In one embodiment, the system provides real-time feedback that includes technical explanations or links to resources for participants with a lesser knowledge level. During the conversation, the large language model (LLM) module 204 continuously analyzes the predictability of utterances and the level of alignment between the participants. The technical depth assessment module 214 evaluates the complexity and technicality of the conversation, identifying instances where one participant may be using terms or concepts that are not well understood by the other party. When the system detects that one participant is using complex terms or concepts that the other party may not be familiar with, the feedback renderer 212 generates a suggestion for the participant with the lower knowledge level. This feedback can include brief technical explanations or links to external resources that provide more detailed information. The feedback can be delivered through various methods, such as a pop-up notification on a mobile application, a desktop notification, or an email.

For example, during a technical discussion about machine learning, if one participant frequently uses terms like “neural networks” and “backpropagation,” which the other party may not fully understand, the system can provide brief explanations or links to resources. The feedback might include a message like, “Neural networks are a type of machine learning model inspired by the human brain. Click here to learn more,” with a link to a relevant article or tutorial. Similarly, for “backpropagation,” the feedback might say, “Backpropagation is an algorithm used to iteratively train neural networks by adjusting weights. Click here for a detailed explanation.” By providing these technical explanations or links to resources, the system helps participants with a lesser knowledge level better understand the conversation. This approach enhances conversational concordance by ensuring that all participants have access to the information they need to follow the discussion. The feedback mechanism is designed to be supportive and informative, allowing participants to learn and engage more effectively without disrupting the flow of the conversation.

In one embodiment, the system leverages the large language models (LLMs) of two participants in a conversation to technically translate the communication between them, thereby improving their conversational concordance. This approach helps to ensure that both participants can understand each other more effectively, even if they have different levels of technical knowledge or use different terminologies. When a conversation begins, the system first identifies the participants and retrieves their respective LLMs. Each LLM is trained on the participant's personal corpus, which includes writings, spoken utterances, and other relevant data. This training allows the LLMs to understand the unique communication style, vocabulary, and technical knowledge of each participant. As the conversation progresses, the system continuously monitors the dialogue in real-time. The conversation monitoring agent captures the audio or text data and sends it to the parsing agent, which converts the data into a structured format, including text, pauses, and intonation markings. This structured data is then analyzed by the LLMs of both participants.

For example, if Participant A uses a highly technical term or concept that Participant B may not be familiar with, the LLM of Participant A recognizes this and translates the term into simpler language or provides an explanation. This translation is then sent to Participant B's LLM, which further adapts the explanation to match Participant B's communication style and vocabulary. The translated message is then delivered to Participant B in real-time, ensuring that they can understand the technical term or concept without interrupting the flow of the conversation. Conversely, if Participant B responds with a term or concept that is less technical or uses different terminology, Participant A's LLM can translate the response into a more technical language that aligns with Participant A's understanding. This bidirectional translation ensures that both participants can communicate effectively, regardless of their individual technical knowledge or terminological differences.

The system also provides feedback to both participants based on the concordance scores calculated by the scoring agent. These scores indicate how well the conversation aligns with the expected flow and highlight areas where one participant may be speaking “over the head” of the other. The feedback renderer generates visual or spoken feedback, offering suggestions for improving communication alignment, such as using simpler terms or providing additional explanations. By leveraging the LLMs of both participants to technically translate the communication, the system enhances conversational concordance and ensures that both parties can understand each other more effectively. This approach helps to reduce misunderstandings, fosters better communication, and improves the overall quality of the conversation.

This invention improves the functioning of a computer by leveraging advanced natural language processing (NLP) techniques and large language models (LLMs) to enhance real-time communication analysis and feedback. The system processes real-time audio or text data from conversations, converting it into structured formats that include text, pauses, and intonation markings. This real-time data processing capability allows the computer to analyze ongoing conversations dynamically, providing immediate feedback to users and enhancing the computer's ability to handle and process large volumes of data efficiently and quickly. By utilizing LLMs, the system can understand and predict the flow of conversations with high accuracy. The LLMs analyze the context, vocabulary, and structure of the conversation, enabling the computer to assess the predictability of utterances and determine the level of alignment between participants, thereby improving the computer's ability to interpret and respond to human language.

The user interface allows users to input goals and parameters for the conversation assessment process, and the system provides visual or spoken feedback based on concordance scores, helping users adjust their communication style in real-time. This interactive feedback mechanism enhances the computer's ability to engage with users and provide meaningful, context-aware responses. The technical depth assessment module evaluates the complexity and technicality of the conversation, adjusting the expected rate of convergence and providing more accurate feedback. This dynamic adjustment capability allows the computer to tailor its feedback based on the specific context of the conversation, improving the relevance and effectiveness of the feedback provided.

The system extends its capabilities to handle conversations involving more than two parties, providing feedback on pairwise conversations between each pair of parties and aggregating the feedback to show how well each party is communicating with the group. This multi-party support enhances the computer's ability to manage and analyze complex conversational dynamics. The corpus management module manages the corpora of documents and previous conversations for each party, ensuring that the LLM module has access to relevant data for training and analysis. By incorporating historical data, the system improves the accuracy of the concordance assessment and provides more relevant feedback, enhancing the computer's ability to learn from past interactions and improve its performance over time.

While the foregoing is directed to embodiments of the present disclosure, other and further embodiments of the present disclosure may be devised without departing from the basic scope thereof, and the scope thereof is determined by the claims that follow.

What is claimed is:

1. A method for identifying that a user in a multi-party conversation is speaking in a way that is likely to be misunderstood by one or more of the parties to the multi-party conversation, the method comprising:
receiving a user corpus associated with the user, wherein the user corpus comprises one or more of writings created by the user and user utterances spoken by the user;
determining that a multi-party conversation has begun;
identifying one or more parties participating in the multi-party conversation;
translating one or more utterances from the multi-party conversation into text in real time;
identifying a speaking party of the one or more parties in real time as each utterance is spoken;
generating a party corpus for each of the one or more parties;
for each of the one or more parties, computing, by a large language model (LLM), a conversational concordance between the user and each party based on the user corpus and a respective associated party corpus, wherein the concordance comprises a probability that a given utterance would have been the next utterance in the multi-party conversation between the user and the party;
providing feedback to the user based on the concordance.

2. The method of claim 1, further comprising dynamically estimating a technical depth of the multi-party conversation based on a technical vocabulary associated with the one or more utterances.

3. The method of claim 2, wherein the feedback comprises a graph tracking the concordance against what is expected for the multi-party conversation based on the technical depth.

4. The method of claim 1, wherein the conversational concordance between the user and each party is further based on one or more of a convergence of a pace of speech of the user and each party.

5. The method of claim 1, wherein the party corpus comprises all utterances spoken by the associated party within the multi-party conversation.

6. The method of claim 1, wherein the party corpus comprises utterances spoken by the associated party within one or more previous conversations.

7. The method of claim 1, wherein the party corpus comprises one or more writings created by the associated party.

8. The method of claim 2, wherein the party corpus comprises a recent conversation between the user and the associated party with a vocabulary exceeding a threshold similarity to the technical vocabulary.

9. A system comprising:
a memory comprising computer readable instructions; and
a processing device for executing the computer readable instructions, the computer readable instructions controlling the processing device to perform operations comprising:
receiving a user corpus associated with the user, wherein the user corpus comprises one or more of writings created by the user and user utterances spoken by the user;
determining that a multi-party conversation has begun;
identifying one or more parties participating in the multi-party conversation;
translating one or more utterances from the multi-party conversation into text in real time;
identifying a speaking party of the one or more parties in real time as each utterance is spoken;
generating a party corpus for each of the one or more parties;
for each of the one or more parties, computing, by a large language model (LLM), a conversational concordance between the user and each party based on the user corpus and a respective associated party corpus, wherein the concordance comprises a probability that a given utterance would have been the next utterance in the multi-party conversation between the user and the party;
providing feedback to the user based on the concordance.

10. The system of claim 9, wherein the operations further comprise dynamically estimating a technical depth of the multi-party conversation based on a technical vocabulary associated with the one or more utterances.

11. The system of claim 10, wherein the feedback comprises a graph tracking the concordance against what is expected for the multi-party conversation based on the technical depth.

12. The system of claim 9, wherein the conversational concordance between the user and each party is further based on one or more of a convergence of a pace of speech of the user and each party.

13. The system of claim 9, wherein the party corpus comprises all utterances spoken by the associated party within the multi-party conversation.

14. The system of claim 9, wherein the party corpus comprises utterances spoken by the associated party within one or more previous conversations.

15. The system of claim 9, wherein the party corpus comprises one or more writings created by the associated party.

16. The system of claim 10, wherein the party corpus comprises a recent conversation between the user and the associated party with a vocabulary exceeding a threshold similarity to the technical vocabulary.

17. A computer program product for identifying that a user in a multi-party conversation is speaking in a way that is likely to be misunderstood by one or more of the parties to the multi-party conversation, the computer program product comprising:
a set of one or more computer-readable storage media;
program instructions, collectively stored in the set of one or more storage media, for causing a processor set to perform the following computer operations:
receiving a user corpus associated with the user, wherein the user corpus comprises one or more of writings created by the user and user utterances spoken by the user;
determining that a multi-party conversation has begun;
identifying one or more parties participating in the multi-party conversation;
translating one or more utterances from the multi-party conversation into text in real time;
identifying a speaking party of the one or more parties in real time as each utterance is spoken;
generating a party corpus for each of the one or more parties;
for each of the one or more parties, computing, by a large language model (LLM), a conversational concordance between the user and each party based on the user corpus and a respective associated party corpus, wherein the concordance comprises a probability that a given utterance would have been the next utterance in the multi-party conversation between the user and the party;
providing feedback to the user based on the concordance.

18. The computer program product of claim 17, wherein the operations further comprise dynamically estimating a technical depth of the multi-party conversation based on a technical vocabulary associated with the one or more utterances.

19. The computer program product of claim 18, wherein the feedback comprises a graph tracking the concordance against what is expected for the multi-party conversation based on the technical depth.

20. The computer program product of claim 17, wherein the conversational concordance between the user and each party is further based on one or more of a convergence of a pace of speech of the user and each party.
